(19) United States
(12) Patent Application Publication
(10) Pub. No.: US 2005/0183323 A1
(43) Pub. Date: Aug. 25, 2005

(54) Jig fish lure

(76) Inventor: Eric A. Harrell, Pickens, SC (US)

Correspondence Address: BROWN & MICHAELS, PC;400 M & T BANK BUILDING, 118 NORTH TIOGA ST, ITHACA, NY, 14850, US

(21) Appl. No.: 11/115,617

(22) Filed: Apr. 27, 2005

Related U.S. Application Data
(63) Continuation-in-part of application No. 10/637,789, filed on Aug. 8, 2003.
(60) Provisional application No. 60/445,887, filed on Feb. 6, 2003.

(51) Int. Cl. A01K 85/00

(52) U.S. Cl. 43/42.39; 43/42.4

(57) ABSTRACT

A jig fish lure having a body and a hook attached to the body. An eye allows attachment of fishing line to the lure. The eye is located to the rear of the body, in a recess behind the body itself, with a cavity in front of the recess, so that fish line knotted to the eye is shielded by the body of the lure. The fishing line is led from the front of the body to the eye in the rear through a passage through the body. Weed guards may optionally be provided.

### REFERENCE TO RELATED APPLICATIONS

This application is a Continuation-In-Part of copending application Ser. No. 10/637,786, filed Aug. 8, 2003, and entitled “JIG FISH LURE”, which claims an invention which was disclosed in Provisional Application No. 60/445,887, filed Feb. 6, 2003, entitled “JIG FISH LURE”. The benefit under 35 USC § 119(e) of the United States provisional application is hereby claimed, and the aforementioned applications are hereby incorporated herein by reference.

### BACKGROUND OF THE INVENTION

1. Field of the Invention

The invention pertains to the field of fish lures. More particularly, the invention pertains to a jig that is less susceptible to be caught on underwater debris.

2. Description of Related Art

The sport of bass fishing is gaining momentum across the Nation as the #1 participatory sport in America. The sport's exposure is multifaceted and includes; National TV, magazines, and tournaments, which are supported by some of the largest companies in America. Bass fishing is currently a 4 billion dollar per year industry and over 60 million Americans participate in it.

The principal anatomy of the bass fishing jig currently sold on today's market is similar among competing companies: simply, there is a weighted body having a hook with an eye hole at the front end. Around this front end (usually called the “head” of the jig) different metals are molded to add weight to the lure.

All jigs on the market today have the eye of the hook located at the front or top of the lure, therefore, the knot is tied at the front or top of the lure, which is the area on a jig that is most susceptible to getting caught on weeds/rocks or wood.

Hawkins, “Reusable Simulated Bait Fish with Insertable Head and Hook”, US Published Application No. 2003/0024150, shows a jig of this kind, which is encased in rubber simulation of live bait. Hawkins' eye is on the top of the body, and extends outward without shielding.

For those jigs used in weeds or around wood (heavy cover) a “weed guard” is used to prevent the hook from getting “snagged” or caught on surrounding “cover.” The vast majority of weed guards consist of a few dozen thin pieces of hard plastic, which project from the head of the jig and stop just above the hook point. The jig almost always has a “skirt” that extends back from the jig head to the bottom of the hook.

Wilson and Murray, “Fishing Lure”, U.S. Pat. No. 5,175,955 shows a jig-type lure similar in overall appearance to the invention. However, the hook in Wilson's lure does not have any eye—the shank end of the hook is buried in the body of the jig. The line passes through the body, and is wrapped around the hook, where it is exposed behind a shank portion and point of the jig body. Lacking an eye, Wilson by definition also lacks a recess or cavity into which the eye is recessed.

### SUMMARY OF THE INVENTION

The jig fish lure of the invention has a body and a hook attached to the body. An eye allows attachment of fishing line to the lure. The eye is located at the rear of the body, in a recess or cavity behind the body itself, so that fish line knotted to the eye is shielded by the body of the lure. The fishing line is led from the front of the body to the eye in the rear through a passage through the body. Weed guards may optionally be provided.

### BRIEF DESCRIPTION OF THE DRAWING

FIG. 1 shows a side view of an embodiment of the present invention.

FIG. 2 shows a top view of the embodiment of FIG. 1.

FIG. 3 shows a bottom view of the embodiment of FIG. 1.

FIG. 4 shows a side view of another embodiment of the invention.

FIG. 5 shows a bottom view of the embodiment of FIG. 4.

FIG. 6 shows a detail from FIG. 5, showing an enlargement of the area enclosed by dashed lines 6-6.

FIG. 7 shows a front perspective view of the embodiment of FIG. 4.

FIG. 8 shows a bottom-rear view of the embodiment of FIG. 4.

### DETAILED DESCRIPTION OF THE INVENTION

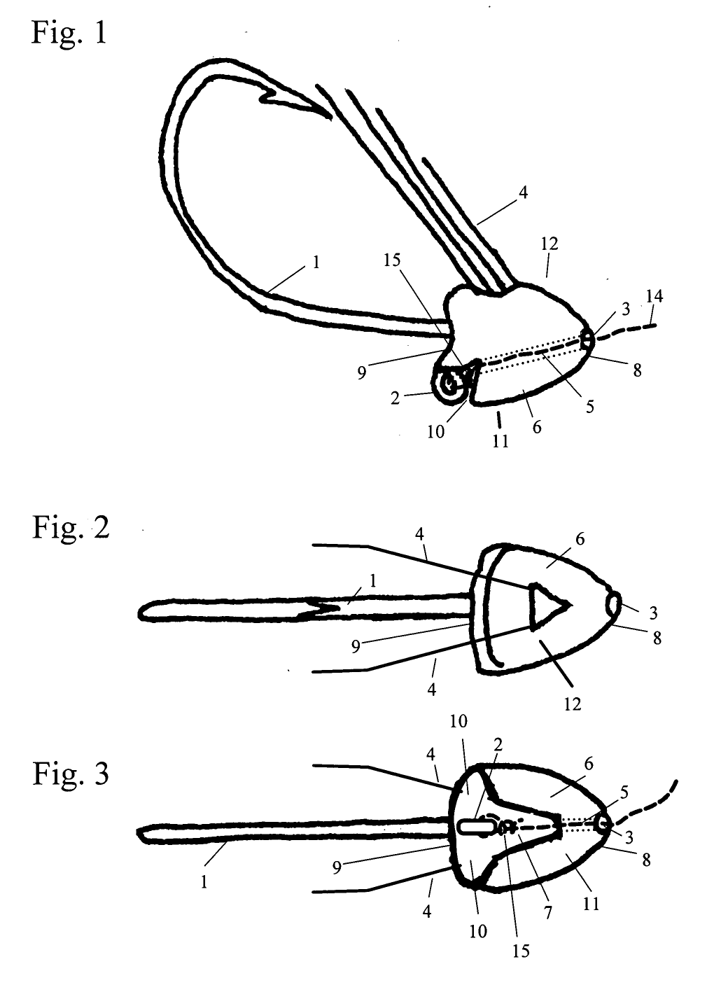

FIGS. 1 to 3 show a drawing of one embodiment of the fish lure of the invention. The exact form of the body may be chosen from among the wide variety of designs known to the art, within the teachings of the invention.

The lure has a body (6) which is preferably solid, and can be made of plastic, metal, wood or some other material as is known to the art of making lures. A hook (1) extends from the rear (9) of the body (6), the weight of the body of the jig being distributed so as to define upper (12) and lower (11) surfaces as shown in the figures when the jig is in use. That is, the weighed body is asymmetrical around the hook, so that when in use the jig will tend to rotate to put the upper side upwards.

The form of the hook (1) is conventional and may vary within the teachings of the invention. As is conventional in fish lures, an eye (2) is provided to which the fishing line (14) may be tied in a knot (15). The eye of the hook may be made either bending the hook back on itself or having a separate eye welded/molded into place.

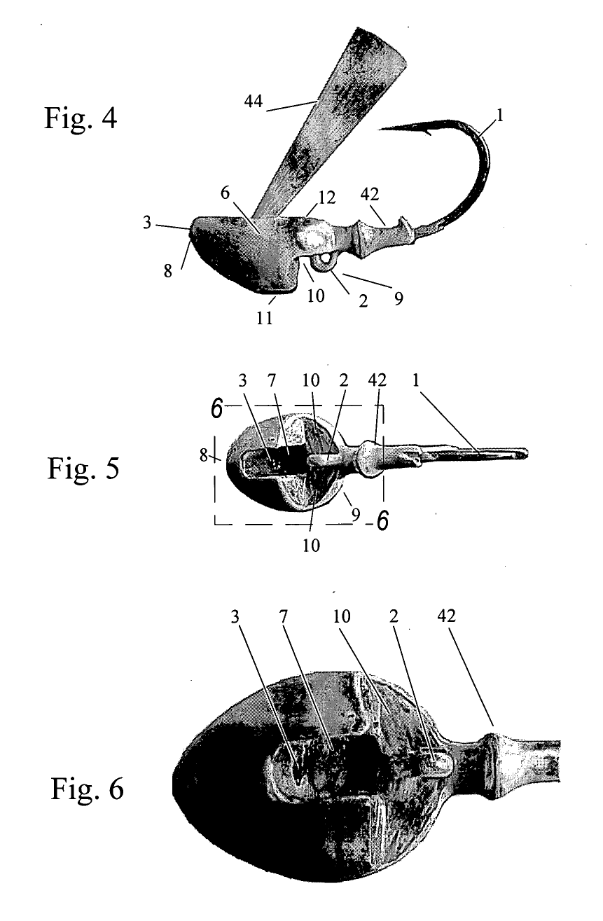

Optionally, one or more weed guards (4) may be provided to minimize the likelihood that the lure will catch on weeds—four weed guards are shown in FIG. 1, two in FIGS. 2 and 3, and a brush-style guard (44) is shown in FIGS. 4-8, but it will be understood that the number and arrangement of weed guards may vary, and they may be omitted entirely.

In the lure of the invention, and in contrast to the prior art lures, the eye (2) is located at the rear (9) of the body (6). The body (6) is cut across, undercut or recessed with a recess (10) on either side of the eye (2). The recess (10) provides access to the eye, so that the user may easily tie the line (14) to the eye (2). A cavity (7) extends forward of the recess (10), forming a space into which a knot may fit, as explained below. The recess and the cavity have a sufficient depth that the eye (2) does not extend below the lower surface (11) of the body, thus shielding a knot (15) tied to the eye (2).

The fishing line (14) is routed through a hole (3) at the front (8) of the body (6), through a tunnel (5) into the cavity (7), and then a knot (15) is tied to the eye (2) at the rear of the body.

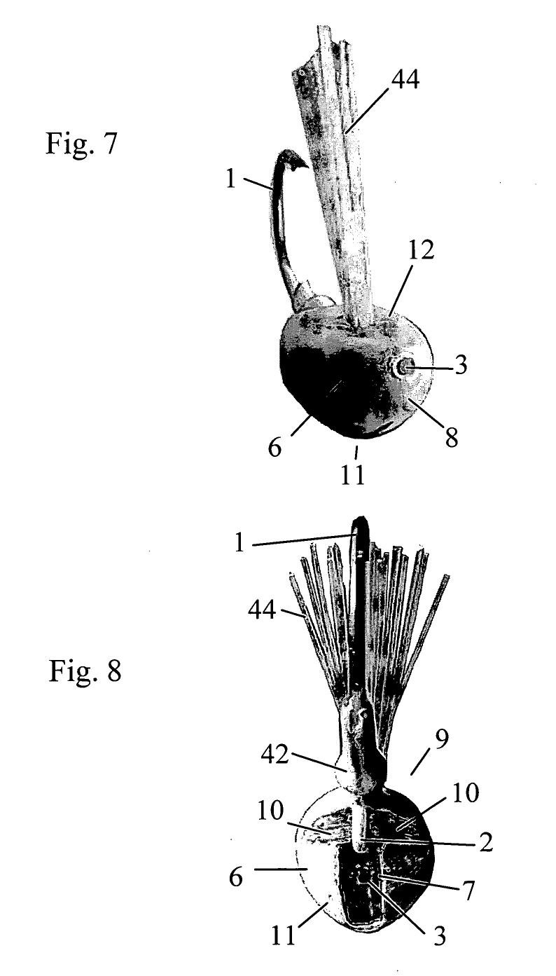

The location of the eye in the recess and the knot in the cavity, shielded by the body, protects the knot's strength and hides it from catching on any underwater cover (weeds, rocks, wood). FIG. 7, which is a front perspective view of the lure, shows this clearly—the while the hook (1) and body (6) are visible, the eye is shielded by the body (6) and not visible in this view.

The jig shown in FIGS. 4 through 8 has a slightly different body shape, with a head shank portion (42) around the base of the hook (1), and brush elements (44) in place of weed guards (4). Otherwise, the design of the embodiment of FIGS. 4 through 8 is similar to the one shown in the drawing FIGS. 1 to 3.

In the preferred embodiment where the body (6) of the jig is made of a molded metal, the recesses (7) and (10) may be easily formed by inserts placed in the mold. Alternatively, they may be formed by cutting the body back, or by other methods known to the art.

The design of the jig allows the line (14) to pass through a tunnel (3) at the front (8) of the jig and be tied in a knot (15) to the eye (2) at the back (9) of the lure. The knot (15) on the line will be hidden inside the cavities (7) and (10) and shielded by the body (6) of the lure. This will make the jig less susceptible to getting caught on any underwater cover (weeds, rocks, wood).

Accordingly, it is to be understood that the embodiments of the invention herein described are merely illustrative of the application of the principles of the invention.

1. A jig fish lure comprising:
a) a weighted body having a front and a rear, and an upper surface and a lower surface, the body having a recess across the lower surface of the body extending from the rear of the body toward the front of the body, a cavity extending from the recess further into the lower surface of the body toward the front of the body, and a passage extending from the front of the body to the cavity;
b) a hook extending from the rear of the body;
c) an eye for attaching fishing line, located in the recess adjacent the rear of the body; and
d) the recess and the cavity having a sufficient depth so that the eye does not extend below the lower surface of the body;
such that when a line is passed through the passage into the cavity and tied in a knot around the eye in the recess, the knot is shielded by the body.

2. The jig fish lure of claim 1, in which the cavity is centered relative to a centerline of the body.

3. The jig fish lure of claim 1, in which the passage is a tunnel through the body.

4. The jig fish lure of claim 1, further comprising at least one weed guard attached to the body and shielding the hook.
